(19) United States
(12) Patent Application Publication
(10) Pub. No.: US 2002/0018402 A1
(43) Pub. Date: Feb. 14, 2002

(54) Network subscriber for improved time synchronization accuracy and associated method therefor

(75) Inventors: Fridolin Egle, Durmersheim (DE); Christoph Muench, Eggenstein-Leopoldshafen (DE)

Correspondence Address: SUGHRUE, MION, ZINN,, MACPEAK & SEAS, PLLC, 2100 Pennsylvania Avenue, NW, Washington, DC, 20037-3213, US

(73) Assignee: SIEMENS AG

(21) Appl. No.: 09/860,555

(22) Filed: May 21, 2001

Related U.S. Application Data
(63) Continuation of application No. PCT/DE99/03647, filed on Nov. 16, 1999.

(30) Foreign Application Priority Data
Nov. 20, 1998 (DE) 29820820.2

(51) Int. Cl. G04C 11/00; G04C 13/00

(52) U.S. Cl. 368/46

(57) ABSTRACT

A network subscriber (2c) is provided with a clock (8) and is connected to a further network subscriber (2a) via a network (1). In a receiving mode, the further network subscriber (2a) supplies a time message (5, Uₙ) containing a time of day to the network subscriber (2c). The network subscriber (2c) includes a synchronization assembly in the form of an adjustment unit (10) that permits improved synchronization accuracy of the time of day. If a deviation between the time of the day included in the time message (5, Uₙ) and a further time of the day indicated by the clock (8) is smaller than a predefined limit value, the synchronization assembly synchronizes the clock (8) with the time of the day that is included in the time message (5, Uₙ) supplied by the further network subscriber (2a). If the deviation between the time of the day included in the time message (5, Uₙ) and the further time of the day indicated by the clock (8) is greater than the predefined limit value, the synchronization assembly determines respective deviations between the times of the day included in successive time messages (5, Uₙ) and associated further times of the day indicated by the clock (8), in order to synchronize the clock (8) with an adjusted time of the day after a predefined interval has elapsed, wherein the adjusted time of the day results from one of the associated times of the day and the smallest one of the respective deviations.

This is a Continuation of International Application PCT/DE99/03647 with an international filing date of Nov. 16, 1999, which was published under PCT Article 21(2) in German, and the complete disclosure of which is incorporated into this application by reference.

### FIELD OF AND BACKGROUND OF THE INVENTION

The present invention relates to a network subscriber, which has a clock and which is connected to a further network subscriber via a network. Therein, the network subscriber has an arrangement for synchronizing its clock. In a receiving mode, the further network subscriber supplies a time message containing a time of day to the network subscriber.

Such a network subscriber is known from Siemens catalog ST 70, chapter 12, 1997 edition. This network subscriber is suitable in a distributed automation system that includes a number of automation components. These automation components must be synchronized for controlling a technical process in accordance with the automation task at hand. To this end, a time transmitter that is connected to the network cyclically transmits a time message via broadcasting or multicasting. This time message is part of a message queue that includes a number of messages. The automation components use this transmitted time message to synchronize their clocks. Due to delay times of the time message in the transmitter, in the receiver and in the transmission path, the received time of day contained in the time message must be corrected before the network subscriber clock is synchronized with this time of day.

German Utility Model Application 298 19 806.1 proposes to enable a network subscriber to correct delay times between the instant when the time is entered into a time message and the instant when it is transmitted, and to correct delay times between the instant when the time message is received and the instant when the time of day is further processed. This German Utility Model Application 298 19 806.1 corresponds to International Application PCT/DE99/03443 (published as WO 00/28400), which was filed in the United States as a Continuation Application (application number unknown) on May 7, 2001, and the full disclosure of which is incorporated herein by reference.

### OBJECTS OF THE INVENTION

It is one object of the present invention to provide a network subscriber having a time synchronization accuracy that is improved compared to the time synchronization accuracy achieved in network subscribers in the prior art.

### SUMMARY OF THE INVENTION

According to one formulation of the present invention, this and other objects of the present invention are achieved by providing a network, which includes a first network subscriber and a second network subscriber connected thereto, wherein, in a receiving mode of the second network subscriber, the first network subscriber supplies a time message to the second network subscriber. This time message includes a time of the day. The second network subscriber includes a clock, which indicates a further time of the day, and a synchronization assembly. If a deviation between the time of the day included in the time message and the further time of the day indicated by the clock is smaller than a predefined limit value, then the synchronization assembly synchronizes the clock with the time of the day that is included in the time message. If the deviation between the time of the day included in the time message and the further time of the day indicated by the clock is not smaller than the predefined limit value, then the synchronization assembly determines respective deviations between the times of the day included in successive time messages and associated further times of the day indicated by the clock. Thereafter, the clock is synchronized with an adjusted time of the day after a predefined interval has elapsed. The adjusted time of the day results from one of the associated times of the day and the smallest one of the respective deviations.

An underlying idea of the present invention is to determine whether a received time message was less delayed than the previous time message whose time of day was last used to synchronize the clock of the receiving network subscriber. To this end, the time of day contained in the time message is compared with the clock of the network subscriber. If the network subscriber clock's time of the day is less advanced than the time of day contained in the received time message, then the time message was less delayed than the previous time message whose time of day was last used to synchronize the clock. If the network subscriber clock's time of the day is the same as the time of day contained in the received time message, then the time message was equally delayed as the previous time message whose time of day was last used to synchronize the clock. In these two cases, the clock of the network subscriber is resynchronized with the time of day contained in the received time message. If, on the other hand, the network subscriber clock's time of the day has more advanced than the time of day contained in the received time message, then the time message was more delayed than the previous time message whose time of day was last used to synchronize the clock. In this case, the clock of the network subscriber is synchronized with an adjusted time of day after a predefined time interval has elapsed. For successive time messages, the respective deviations between the time of day of the network subscriber's clock and the time of day contained in the successive time messages are determined. In this case, the adjusted time of day results from the current time of the network subscriber's clock and the smallest one of these respective deviations.

### BRIEF DESCRIPTION OF THE DRAWINGS

The invention and further advantageous refinements of the invention according to the features of the dependent claims are explained in more detail below with the aid of diagrammatic, exemplary embodiments in the drawings, in which:

FIG. 1 is a schematic diagram of a network in accordance with the present invention; and

FIG. 2 is a time diagram of time messages in accordance with the present invention.

### DETAILED DESCRIPTION OF THE PREFERRED EMBODIMENTS

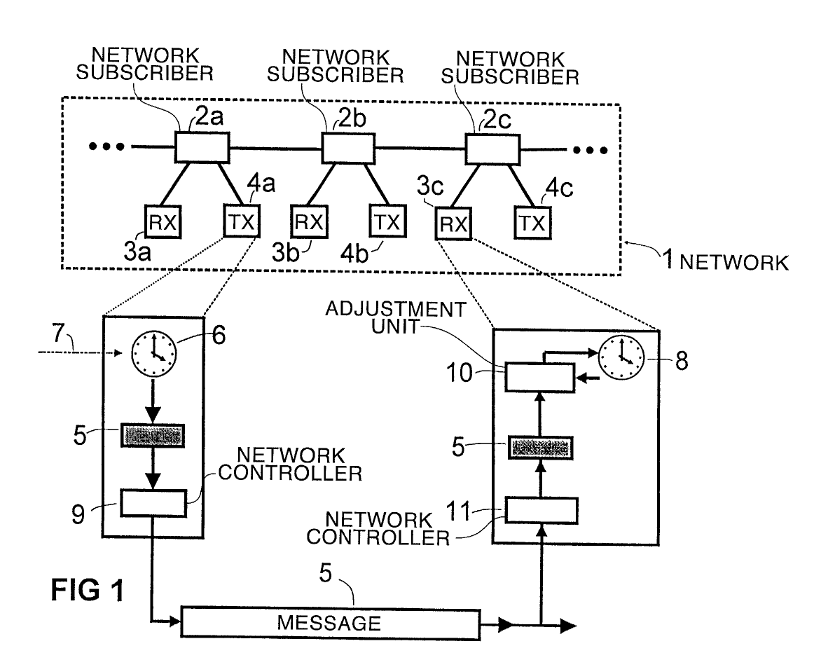

FIG. 1 shows a network 1, e.g., a local area network (LAN), to which network subscribers 2a, 2b, 2c, . . . are connected. Each of the network subscribers 2a, 2b, 2c, . . . has a respective receiver 3a, 3b, 3c, . . . and a respective transmitter 4a, 4b, 4c, . . . In the preferred embodiment of FIG. 1, it is assumed that the transmitter 4a of the network subscriber 2a transmits a message 5 to the receiver 3c of the network subscriber 2c. The time message 5 contains the time of day of a clock 6 of the network subscriber 2a, which can be externally synchronized by a signal 7. A clock 8 of the network subscriber 2c is to be synchronized with the time of day that was entered into the time message 5 at a corresponding instant of entry. In the preferred embodiment of FIG. 1, it is further assumed that the time difference between the instant when the time of day is entered into the time message 5 and the instant when the time message 5 is transmitted by a network controller 9 of the transmitter 4a is negligible. Alternatively, it is assumed that suitable means, such as those described in German Utility Model Application 298 19 806.1, are used to correct this time difference.

To prevent an incorrect synchronization of the clock 8 of the network subscriber 2c with the time of day of the network subscriber 2a, the deviations caused by line delays must be compensated to a great extent. To this end, the receiver 3c of the network subscriber 2c has an adjustment unit 10, to which a network controller 11 of receiver 3c supplies the time message 5 transmitted by the transmitter 4a. This adjustment unit 10 is one example of various software and/or hardware synchronization assemblies that can be configured to perform the synchronization task. The adjustment unit 10 compares the time of day contained in the time message 5 with the time of day of the clock 8 of the receiver 3c. If the deviation between the time of day of the clock 8 and the time of day contained in the time message 5 is smaller than a predefined limit, which can be set in the adjustment unit 10, the adjustment unit 10 synchronizes the clock 8 with the time of day contained in the time message 5. If the deviation between the time of day of the clock 8 and the time of day contained in the time message 5 is greater than the predefined limit, the adjustment unit 10 synchronizes the clock 8 with an adjusted time of day after a predefined time interval has elapsed. The adjustment unit 10 forms this adjusted time from the current time of day of the clock 8 and the smallest deviation. To this end, the adjustment unit 10 determines respective deviations between the time of day of the clock 8 and the time of day contained in the time message 5 for successive time messages 5 during the predefined time interval. Thereafter, the adjustment unit 10 determines the minimum of the deviations.

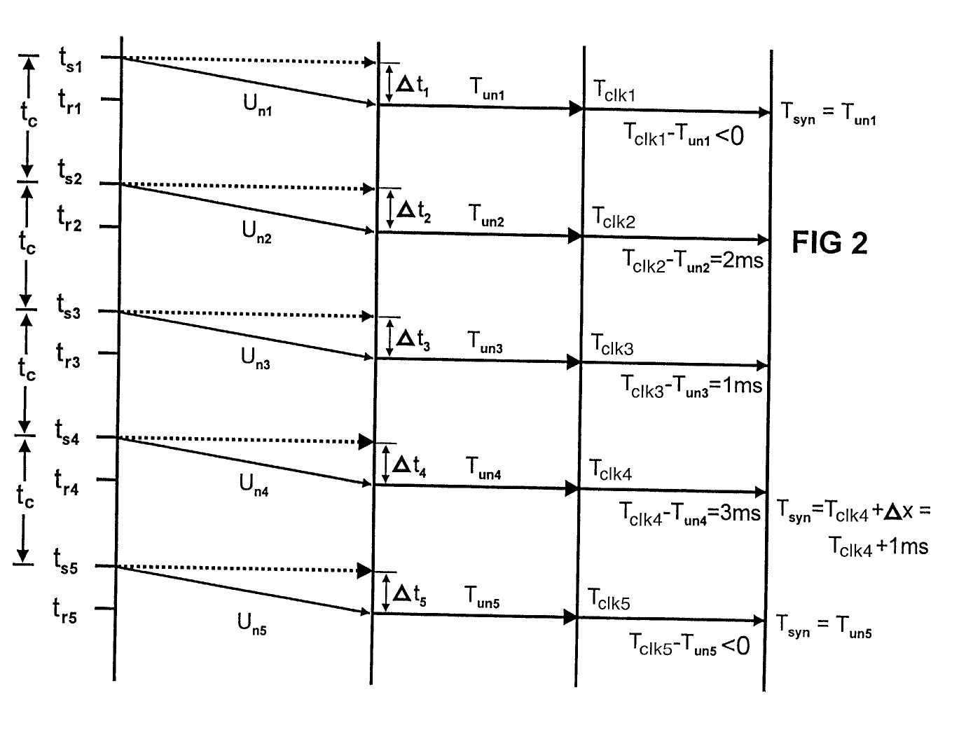

To illustrate the time adjustment, reference is made to FIG. 2, which shows a time diagram of time messages.

A transmitter 4 cyclically transmits time messages Uₙ₁, Uₙ₂, . . . containing times of day Tᵤₙ₁, . . . Tᵤₙ₂, . . . at instances t_{S1}, . . . t_{S2}, . . . Therein, the transmitter has a cycle time t_{c}. A receiver receives the time messages Uₙ₁, . . . Uₙ₂, . . . at instants tᵣ₁, tᵣ₂, . . . with respective time-shifts of Δt₁, Δt₂, . . . . In addition, the receiver processes the time messages Uₙ₁, . . . Uₙ₂, . . . further. For the sake of simplicity, it is assumed that the instants of reception and the instants of further processing of the time messages Uₙ₁, Uₙ₂, . . . are identical. An adjustment unit 10 compares the times of day Tᵤₙ₁, Tᵤₙ₂, . . . contained in the time messages Uₙ₁, Uₙ₂, . . . with the times of day T_{clk1}, T_{clk2}, . . . of the receiver clock 8 and determines the respective deviations. The adjustment unit 10 then synchronizes the clock 8 of the receiver with the time of day contained in the time message, if the deviation between the time of day contained in the time message and the time of day of the receiver is less than a limit value of 0 milliseconds. In the preferred embodiment shown in FIG. 2, the time of day T_{clk1}<Tᵤₙ₁, i.e., the deviation is less than 0. Consequently, the adjustment unit synchronizes the clock of the receiver with the time of day Tᵤₙ₁ contained in the time message Uₙ₁.

In the preferred embodiment of FIG. 2, the time of day T_{clk2} deviates from the time of day Tᵤₙ₂ contained in the time message Uₙ₂ by two milliseconds. The receiver clock is not synchronized. Instead, for a predefined time interval, e.g., a time interval starting from instant tᵣ₂ up to instant tᵣ₄, the adjustment unit determines the deviations for successive time messages. At instant tᵣ₃, the adjustment unit determines a deviation of one millisecond between the time of day Tᵤₙ₃ contained in time message Uₙ₃ and the clock time T_{clk3}. Further, at instant tᵣ₄, the adjustment unit determines a deviation of three milliseconds between the time of day Tᵤₙ₄ contained in time message Uₙ₄ and the time of day T_{clk4}. This means that, during the predefined time interval, the smallest deviation Δx equals one millisecond at instant tᵣ₃. The adjustment unit then synchronizes the receiver clock at instant tᵣ₄ with an adjusted time of day T_{cIk4}+1 ms, i.e., with the time of day of the receiver clock that is corrected by one millisecond.

The deviation between the receiver time of day T_{clk5} and the time of day Tᵤₙ₅ contained in time message Uₙ₅ is again smaller than the limit value of 0. As a result, the adjustment unit synchronizes the receiver clock with the time of day Tᵤₙ₅ contained in the time message Uₙ₅.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A network, comprising:
a first network subscriber;
a second network subscriber connected to the first network subscriber; wherein, in a receiving mode of the second network subscriber, the first network subscriber is configured to supply a time message to the second network subscriber that includes a time of the day; and wherein the second network subscriber comprises:
a clock indicating a further time of the day;
a synchronization assembly, configured such that
if a deviation between the time of the day included in the time message and the further time of the day indicated by the clock is smaller than a predefined limit value, the synchronization assembly synchronizes the clock with the time of the day that is included in the time message supplied by the first network subscriber; and
if the deviation between the time of the day included in the time message and the further time of the day indicated by the clock is greater than the predefined limit value, the synchronization assembly determines respective deviations between the times of the day included in successive time messages and associated further times of the day indicated by the clock, in order to synchronize the clock with an adjusted time of the day after a predefined interval has elapsed, wherein the adjusted time of the day results from of the associated times of the day and the smallest one of the respective deviations.

2. The network of claim 1, wherein the synchronization assembly determines the respective deviations between the times of the day included in the successive time messages and the associated further times of the day indicated by the clock, if the deviation between the time of the day included in the time message and the further time of the day indicated by the clock is equal to the predefined limit value.

3. The network of claim 1, wherein the adjusted time of the day results from the associated time of the day at which the predefined time interval has elapsed and the smallest one of the respective deviations.

4. A method, comprising:
supplying a time message from a first network subscriber to a second network subscriber, wherein the time message includes a time of the day;
synchronizing a clock of the second subscriber with the time of the day included in the time message, if a deviation between the time of the day included in the time message and a further time of the day indicated by the clock is smaller than a predefined limit value;
if the deviation between the time of the day included in the time message and the further time of the day indicated by the clock is greater than the predefined limit value, determining respective deviations between the times of the day included in successive time messages and associated further times of the day indicated by the clock and synchronizing the clock with an adjusted time of the day after a predefined interval has elapsed, wherein the adjusted time of the day results from one of the associated times of the day and the smallest one of the respective deviations.

5. The method of claim 4, wherein the respective deviations between the times of the day included in the successive time messages and the associated further times of the day indicated by the clock are determined, if the deviation between the time of the day included in the time message and the further time of the day indicated by the clock is equal to the predefined limit value.

6. The method of claim 4, wherein the adjusted time of the day results from the associated time of the day at which the predefined time interval has elapsed and the smallest one of the respective deviations.
